(19) United States
(12) Patent Application Publication
(10) Pub. No.: US 2025/0014037 A1
(43) Pub. Date: Jan. 9, 2025

(54) CONTENT VERIFICATION

(71) Applicant: MASTERCARD INTERNATIONAL INCORPORATED, Purchase, NY (US)

(72) Inventors: Husham HAMDAN, Surrey (GB); Colum DUFFY, Richmond (GB)

(73) Assignee: MASTERCARD INTERNATIONAL INCORPORATED, Purchase, NY (US)

(21) Appl. No.: 18/560,893

(22) PCT Filed: May 3, 2022
(86) PCT No.: PCT/US2022/027380

§ 371 Date: Nov. 14, 2023

(30) Foreign Application Priority Data
May 14, 2021 (GB) 2106960.4

(51) Int. Cl. G06Q 20/40; G06Q 20/12; G06Q 30/0601

(52) U.S. Cl. CPC G06Q 20/4014; G06Q 20/12; G06Q 30/0609

(57) ABSTRACT

A method of processing, at an authentication server, content data provided during an interaction between a user and a third party platform, the method comprising: receiving, at the authentication server, user verification data and content data from the third party platform; verifying the identity of the user by comparing the received user verification data against verification data stored in a user profile in order to generate a user identity status; analysing received content data against pre-existing user data in order to generate a content data notification message; sending, from the authentication server to the third party platform, an authentication message, the authentication message comprising the user identity status and the content data notification message.

### CROSS REFERENCE TO RELATED APPLICATION

This application claims the benefit of United Kingdom Patent Application No. 2106960.4, which was filed on May 14, 2021, the entire contents of which are hereby incorporated by reference for all purposes.

### TECHNICAL FIELD

The present disclosure relates to content verification. In particular, aspects of the present disclosure relate to a method of processing content data and a system for processing content data.

### BACKGROUND

Verification of user (consumer or merchant) information prior to granting access to a service or product may not be straightforward for the third party providing the service or product.

For example, when user set-up an account on a third party platform (such as, but not limited to, Twitter, Facebook, Instagram) in many cases the only check that is performed is to verify the user's email address or mobile number. In some instances, a manual verification process may be performed on a subset of user accounts (e.g. Twitter's verified “blue tick” accounts) but such a process is slow and does not scale well if the more detailed verification is desired across all user accounts.

Verification based on an email address or mobile number may not be enough to give confidence to the third party provider regarding the identity of the user setting up the account or the accuracy of the content data that such a user sends to the third party provider/platform. This may lead to issues such as the creation of fake accounts or accounts that are used to impersonate another user. Verification by email/mobile alone may also make identification of a user difficult in the event that the rules of the third party platform are broken (or the law is broken).

The present disclosure has been devised to mitigate or overcome at least some of the above-mentioned problems.

### SUMMARY OF THE DISCLOSURE

According to a first aspect of the present disclosure, there is provided a method of processing, at an authentication server, content data provided during an interaction between a user and a third party platform, the method comprising: receiving, at the authentication server, user verification data and content data from the third party platform; verifying, at the authentication server, the identity of the user by comparing the received user verification data against verification data stored in a user profile in order to generate a user identity status; analysing, at the authentication server, received content data against user data within the user profile in order to generate a content data notification message; sending, from the authentication server to the third party platform, an authentication message, the authentication message comprising the user identity status and the content data notification message.

The present disclosure provides a method of processing at an authentication server content data provided during an interaction between a user and a third party platform. The method verifies the identity of the user based on verification data provided by the user and then analyses content data against user data within a user profile. The third party platform may be sent an authentication message which comprises the status of the user identity verification (e.g. user's identity verified or unverified) along with the outcome of the analysis of the content data analysis.

The disclosure provides a mechanism that may be used to limit interactions to only those users whose identity can be verified. This enables exposure to fake user accounts to be reduced.

The content data that is provided during the interaction between the user and the third party platform may comprise a review (e.g. a TripAdvisor review) that is to be verified or other content data (e.g. a user photograph) to be verified.

The user profile which stores the verification data may either be held at the authentication server or by another entity (e.g. an issuer banking entity). Analysis of received content data against pre-existing user data in order to generate the content data notification message may comprise checking the received content data relative to historical transaction data that is held in the user profile held by the issuer or authentication server.

The verification data stored in the user profile may comprise user bank account data and the user verification data received at the authentication server may comprise data associated with the user bank account. It is noted that the “user” may either be a consumer or a merchant. Verification of the identity of the user may comprise checking that the received data associated with the user bank account matches the user bank account data stored in the user profile. The user profile may comprise primary account number (PAN) data and the received user verification data may comprise a PAN number. The user profile may also comprise (or alternatively comprise) other user account data such as sort code and account number.

The content data received from the third party platform may relate to a user-merchant transaction between a user and a merchant and, in such an instance, the pre-existing user data may comprise historical transaction data of the user.

Analysing the received content data against pre-existing user data may comprise determining if a match exists between the historical transaction data in the user profile and the user-merchant transaction contained in the received content data.

Content data received from the third party platform may comprise an image of submitted by the user and the pre-existing user data may comprise a profile image of the user. For such content data, the submitted user image may be analysed against the profile image to determine if a match exists between the user in the submitted image and the pre-existing user profile image.

The content data notification message may comprise an indication whether or not a match exists between the content data received from the third party platform and the data within the user profile.

Content data received from the third party platform may comprise a request for pre-existing user data in order to populate a form and analysing the received content data may comprise extracting user data from the pre-existing user data. For such content data, the content data notification message may comprise the user data requested by the third party platform. The content data received from the third party platform may also comprise a content formatting specification and the content data notification message may comprise user data extracted from pre-existing user data and formatted according to the content formatting specification.

The method may further comprise generating at the authentication server a consent notification message to send to the user to allow the user to consent to the verification of their verification data and analysis of content data. The consent notification message may be sent via a second authenticated communications channel, for example the consent notification message may sent via a banking application installed on a user's computing device.

In the event that the user is requesting a third party provider user account, verifying the identity of the user may comprise checking whether the received user verification data is already associated with another third party provider user account.

According to a further aspect of the present disclosure there is provided a computing device comprising a processor, a memory, and communication capability, wherein the computing device is adapted to perform the above method.

According to a yet further aspect of the present disclosure, there is provided a computer program product comprising instructions which, when the program is executed by a computer, cause the computer to carry out the above method.

According to an still further aspect of the present disclosure, there is provided a computer-readable storage medium comprising instructions which, when executed by a computer, cause the computer to carry out the above method.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the disclosure will now be described, by way of example only, with reference to the accompanying drawings, in which:

FIG. 1 shows a service architecture in accordance with embodiments of the present disclosure;

FIG. 2 is a flow chart of an account registration process in accordance with embodiments of the present disclosure;

FIG. 3 is a flow chart of a content data verification process in accordance with embodiments of the present disclosure.

### DETAILED DESCRIPTION

The present disclosure relates to a content data verification method and system in which content data supplied from a user to a third party platform can be analysed and verified. The content data verification methods described herein comprise verifying the identity of the user and, based on the user verification, checking the content data received from the user.

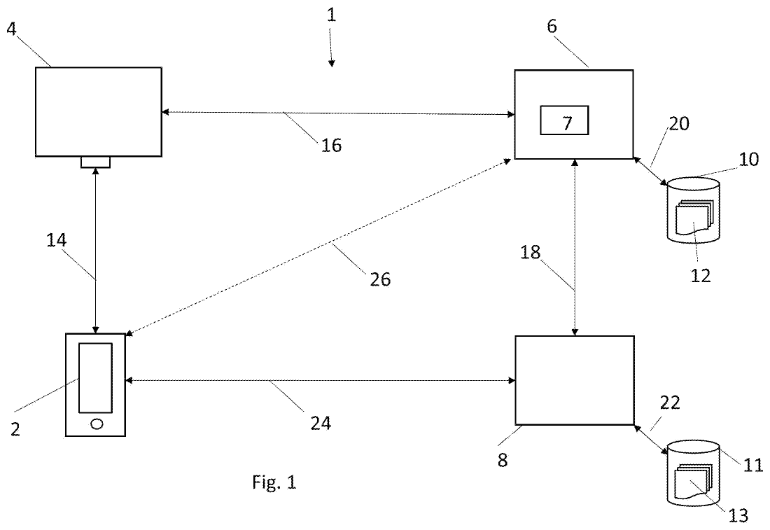

FIG. 1 shows a content data assessment system 1 according to embodiments of the present disclosure. The architecture shows a user device 2, an online service provider (a third party platform) 4, a payment network 6 (comprising a processor 7) and an issuer 8. Also shown is a first data store 10 comprising a first plurality of user profiles 12 and a second data store 11 comprising a second plurality of user profiles 13. The user device 2 is shown to be in communication with the third party platform 4 via a communications link 14. The third party platform 4 is in communication via a second communications link 16 with the payment network 6. The payment network 6 is in communication via a third communications link 18 with the issuer 8.

The first data store 10 may be accessed by the payment network 6 via communications link 20. The second data store 11 may be accessed by the issuer 8 via communications link 22. The issuer 8 may be in communication with the user device 2 via a further communications link 24 (e.g. in the case of the user device 2 being a consumer device then the communications link 24 may be provided by a secure banking app on the user device 2). A further communications link 26 may be provided from the payment network 6 to the user device 2.

In the following description the verification of user verification data and the analysis of content data is described. Such verification and analysis takes place at an authentication server. The following description describes the configuration in which the payment network 6 performs the functions of the authentication server. It is however to be appreciated that alternative configurations may be implemented without changing the underlying verification and analysis steps that are performed. For example, depending on the configuration of the content analysis system 1 the payment network 6 may perform all the functions of the authentication server. Alternatively, the issuer 8 may perform the functions of the authentication server. In further configurations the functions of the authentication server may be performed in a distributed manner by both the payment network 6 and issuer 8. Two separate data stores (10 and 11) are shown in FIG. 1 containing respectively first and second user profiles (12 and 13). In the following description the user profiles 13 relate to user data that the issuer holds in relation to each user. For example, all payment cards associated with a user, the primary account numbers (PANs) associated with such payment cards and historical transaction data undertaken by the user with one or more of the user's payment cards. The user profiles 12 contain information linking users to the third party platform 4 (e.g. payment card data, and associated PANs, that are linked to user accounts on the third party platform). It is noted that in alternative configurations, however, there may only be a single data store with one set of user profiles that may be accessed by either or both of the payment network 6 and issuer 8.

The user device 2 shown in FIG. 1 is a representation of a consumer mobile telecommunications device. It is noted that other devices may be used by the user to interact with the third party platform (e.g. a computer terminal). It is also noted that the user device may be linked to/associated with a consumer or alternatively may be linked to/associated with a merchant and the verification and content data analysis may relate to verification of the merchant.

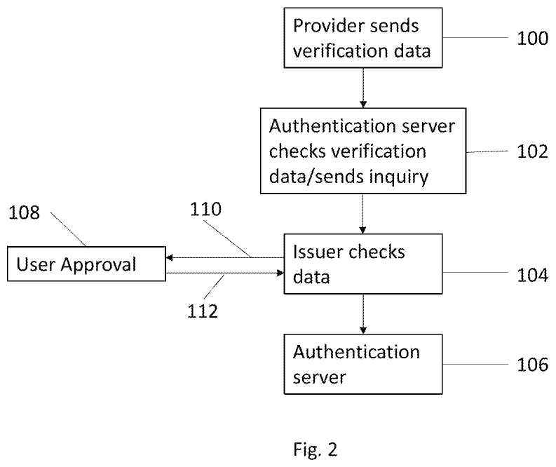

FIG. 2 shows a registration and validation method according to embodiments of the present disclosure. It is noted that where reference is made below to the authentication server 6 performing certain functions it is to be appreciated that the server 6 comprises one or more processors 7 that undertake such functions.

In step 100 the third party platform 4 sends user verification data to the authentication server 6. In one example, the user may have provided payment card credentials (e.g. a primary account number, PAN) along with basic address data (e.g. a postal or ZIP code) to the third party platform during a registration process for an account on the third party platform which is then sent to the server 6.

In step 102 the authentication server 6 may check the verification data against a user profile 12 held in the data store 10 to confirm whether the same verification data has been provided in respect of another account associated with the third party platform. In the event that a pre-existing account exists then the server may send a notification to the third party provider in order that the registration process may be terminated. In the event that the user verification data has not been used to open another account with the third party provider the authentication server 6 sends a verification inquiry (e.g. in the form of an account status inquiry) to the issuer 8. The verification inquiry may comprise the received payment card credentials.

In step 104 the issuer 8 checks the received payment card credentials against the user profiles 13 in the data store 11 to determine if the user has an active payment account with the issuer. In the event that the user verification data is associated with an active payment account the issuer 8 returns confirmation to the server 6 that the payment account associated with the provided payment card credentials is valid. Additionally, the issuer 8 may return basic address data (e.g. postal or ZIP code) to the server 6.

In step 106 the authentication server 6 checks that the user verification data received from the third party platform 4 matches the data provided by the issuer 8 and sends an authentication message (comprising a user identity status indicating whether the provided user verification data has been validated or not) to the third party platform 4 which is then able to complete the registration process for the user account on the platform 4.

In some configurations, during step 104, the issuer 8 may contact the user device 2 via the communications link 24 to check that the user associated with the user device approves the verification process (step 108). Checking the user consents to the verification process may comprise sending a push communication 110 via a pre-installed secure banking app on the user device 2 and then processing a response 112 from the user device 2 back to the issuer 8. In further configurations a similar user consent/approval process may be undertaken by the authentication server 6 via the communications link 26.

The application of the above registration method to two different use cases is now described with reference to the method shown in FIG. 2. In the first use case, the user device is associated with a consumer as the user. In the second use case, the user device is associated with a merchant as the user.

### Consumer Registration

In this use case the user is a consumer and the third party platform is a social media platform. The process begins with the consumer starting a registration process, via their user device 2, for a social media account on the social media platform 4. As part of the registration process the consumer selects an option for a verified account and supplies user verification data as requested by the platform. This user verification data may comprise some or all of: Consumer Name, URL, contact email, address (including postal/ZIP code), payment card details (e.g. PAN, expiry date, CVC2 number). By selecting the verified account option the consumer may be asked to confirm that they consent to a verification lookup being performed with the issuer 8 of their payment card.

Once the platform 4 detects that a valid payment card has been submitted as the payment verification instrument, the social media platform makes an API call to the authentication server 6 (step 100) to verify the associated account. The platform 4 may securely pass the registration data provided by the consumer to the server 6 in an API call.

In step 102, the server 6 checks that the payment card PAN received from the platform 4 has not been used to register another account by looking up the user profiles 12 within the data store 10 to see if any profiles already contain the received user verification data. Note: in step 102, the server 6 is checking that the payment card PAN received from the specific social media platform 4 has not be used to register another account to that same social media platform 4 and this would not prevent the PAN being associated with another platform.

In the event that this is the first instance of the PAN being associated with a social media account on the social media platform 4, the server 6 sends a non-financial authorization message, an Account Status Inquiry (ASI), to the issuer 8. The authorization message may additionally be enabled for an address verification service (AVS). The authorization message to the issuer 8 requests that the issuer checks the user profiles 13 within the data store 11 to determine that the payment card PAN corresponds with a valid account matching the country of registration. In some configurations, the authorization message may include CVC2 data and/or request additional data verifications (for example name verification) to be performed by the issuer 8.

In step 108, the issuer contacts that consumer for consent to carry out the verification by sending a request 110 to the user device 2 to confirm the consumer's intent to create the account. The request 110 may be an SMS to the registered mobile which requests a Y/N response or a pop-up notification in the issuer's mobile banking app. The consumer may provide approval (via communication 112) and consent for the issuer to proceed.

In step 104, the issuer 8 performs an account status check and postal/zip code match (by checking the received verification data against the user profiles 13 within the data store 11) and sends a response back to the authentication server 6 indicating the account status as either Approved or refused (depending on whether the received user verification data matches the data contained within the user profile 13 within the data store 11 or not) along with the outcome of the postal code match check (i.e. the issuer returns the postal code information associated with the user profile).

In step 106, the authentication server 6 responds to the social media platform 4 with an authentication message comprising the user identity status. The user identity status may take the form of a score indicating the likelihood that the user account that has been requested on the social media platform 4 is a genuine account (the verification of the provided user verification data being taken as an indication that the account is genuine). The score can be based on one or more factors such as: has the PAN been used/seen before; the outcome of the account status check; the outcome of the postcode check; any additional verifications/checks.

The social media platform may then make a decision whether to proceed with account opening and grant a verified status or reject the account. The verified account may be given a suitable indication that it is verified, e.g. a coloured tick.

### Merchant Verification

In this use case, the user is a merchant and the third party platform is a social media platform. The process begins with the merchant starting a registration process, via their user device 2, for a social media account on the social media platform 4. As part of the registration process, the merchant selects an option for a verified account and supplies user verification data as request by the platform 4. This user verification data may comprise some or all of: Company Name, URL, contact email, address (including postal/Zip code), payment card details (e.g. the company name on the card, PAN, expiry date, CVC2 number). By selecting the verified account option, the merchant may be asked to confirm that they consent to ta verification lookup being performed with the issuer 8 of their payment card.

Once the platform 4 detects that a valid payment card has been submitted as the payment verification instrument, the social media platform makes an API call to the authentication server 6 (step 100) to verify the associated account. The social media platform 4 may securely pass the registration data provided by the merchant to the server 6 in an API call.

In step 102, the server 6 checks that the payment card PAN received from the platform 4 has not been used to register another account by looking up the user profiles 12 within the data store 10 to see if any profiles already contain the received user verification data. In the event that this is the first instance of the PAN being associated with a social media account for the social media platform 4, the server 6 sends a non-financial authorization message, an Account Status Inquiry (ASI), to the issuer 8. The authorization message may additionally be enabled for an address verification service (AVS). The authorization message to the issuer 8 requests that the issuer checks the user profiles 13 within the data store 11 to determine that the payment card PAN corresponds with a valid account matching the country of registration. [As noted above, in step 102, the server 6 is checking that the payment card PAN received from the specific social media platform 4 has not be used to register another account to that same social media platform 4 and this would not prevent the PAN being associated with another platform.]

In some configurations, the authorization message may include CVC2 data and/or request additional data verifications to be performed by the issuer 8. For example, if the platform 4 is acting as a payment facilitator (PayFac) then the authorisation message may include a request to the issuer 8 to lookup the merchant to see if they are regarded as a high risk merchant.

In step 104, the issuer 8 performs an account status check and postal/zip code match (by checking the received verification data against the user profiles 13 within the data store 11) and sends a response back to the authentication server 6 indicating the account status as either Approved or refused (depending on whether the received user verification data matches the data contained within the user profile 13 within the data store 11 or not) along with the outcome of the postal code match check (i.e. the issuer returns the postal code information associated with the user profile).

In step 106, the authentication server 6 responds to the social media platform 4 with an authentication message comprising the user identity status. The user identity status may take the form of a score indicating likelihood that the user account that has been requested on the social media platform 4 is a genuine account (the verification of the provided user verification data being taken as an indication that the account is genuine). The score can be based on one or more factors such as: has the PAN been used/seen before; the outcome of the account status check; the outcome of the postcode check; any additional verifications/checks.

The social media platform may then make a decision whether to proceed with account opening and grant a verified status or reject the account. The verified account may be given a suitable indication that it is verified, e.g. a coloured tick.

### Content Data Analysis/Verification

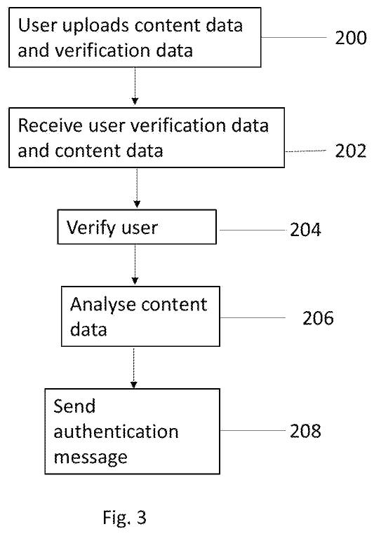

When interacting with the third party platform 4 a user may wish to upload content data that can be verified by the system. FIG. 3 shows a method of processing such content data in accordance with embodiments of the present disclosure. Initially the user uploads the content data and user verification data to the third party platform (step 200). The user verification data that is uploaded may comprise the same type of data used in FIG. 2 (and the user and merchant registration processes) described above, i.e. the user may provide payment card details along with basic address data to the platform 4.

In step 202 the authentication server 6 receives user verification data and content data from the third party platform 4.

In step 204 the identity of the user is verified by the server 6 based on the received user verification data by sending a verification inquiry (e.g. in the form of an account status inquiry) to the issuer 8. The verification inquiry may comprise received payment card credentials. The issuer 8 checks the received payment card credentials against the user profiles 13 within the data store 11 to determine if the provided user verification data relates to an active (user-issuer) account with the issuer. In the event that the user verification data is associated with an active account the issuer 8 returns confirmation to the server 6 that the payment account associated with the provided payment card credentials is valid. Additionally, the issuer 8 may return basic address data (e.g. postal or ZIP code) to the server 6. On the basis of the response from the issuer 8 the authentication server 6 can verify the identity of the user and generate a user identity status (e.g. approved or rejected).

In step 206 the content data is analysed by the authentication server 6. This analysis may comprise sending a further data inquiry communication to the issuer 8 (e.g. to check the presence of historical transaction data within the data store 11 that corresponds with the content data or to check that the received content data matches data held by the issuer). The analysis may also involve retrieving profile data from the data store 10 or the data store 11 and checking that it matches the content data supplied by the user via the third party platform 4 (e.g. in the event that the user has supplied a profile photo then the authentication server 6 may check the user profile 12 within the data store for a pre-existing profile photo and perform a comparison of the two images. Alternatively, the authentication server 6 may request that the issuer 8 check the data store 11 for a pre-existing profile image relating to the user and either request that the issuer 8 carries out an image comparison or request that the issuer 8 supplies a copy of the pre-existing profile image so that the authentication server 6 can carry out the image comparison).

In the event that the content data supplied by the user via the third party platform 4 can be analysed and verified then the authentication server generates a content data notification message with details of the outcome of the content data analysis (e.g. the content data notification message may confirm that the user has undertaken a transaction with a specific merchant or the content data notification message may confirm that the image submitted by the user to the third party platform 4 corresponds with a pre-existing profile image).

In step 208 the authentication server generates an authentication message to send to the third party platform, the authentication message comprising the user identity status and the content data notification message.

An example of the content data analysis method according to the present disclosure is now discussed in conjunction with FIG. 3.

The present example relates to a user (e.g. a consumer) uploading a merchant review of a product/service to either a merchant website or independent review website. The merchant/independent review website is to be regarded as the third party platform 4 in this example.

In step 200, the user creates their merchant review and provides data such as their third party platform user account name (which may for example correspond with their email), review date, merchant name (that the review relates to), address and review content (text, photos, ratings) along with the date of the transaction with the merchant. In addition to this data they additionally select an option to make the review a “verified review”. The user then provides user verification data in the form of payment card details, e.g. by providing the PAN number for the payment card used at the merchant.

In step 202, the authentication server 6 receives the provided user verification data from the third party platform 4 along with content data in the form of the merchant name and the date of interaction between the user and merchant. The content data may be accompanied with a request from the third party platform 4 to analyze and verify the accuracy of the content data.

In step 204, the authentication server 6 detects the presence of payment card details within the user verification data and generates a verification inquiry to the issuer 8 to verify the received payment card data.

In step 206 the authentication server 6 also detects the presence of the request to verify the accuracy of the content data and additionally generates a request to the issuer 8 to look up a transaction between the user and the merchant (the server 6 may provide a date of the transaction to the issuer 8).

It is noted that steps 204 and 206 may occur together and the server 6 may generate a combined request to the issuer 8 to check that the payment card data relates to an active payment card and that the payment card is associated with a transaction with the merchant. In the event that the issuer 8 determines that the user verification data relates to an active account then the authentication server may generate a user identity status indicating that the user is verified. In the event that the issuer 8 determines that the provided payment card has undertaken a transaction with the merchant (on the specified date or date range) then the issuer can return an indication to the server 6 that a matching transaction is present in the historical transaction data in the user profile 13 of the user. The authentication server 6 is then able to generate a content notification message that indicates that there is a match between the received content data and the data within the user profile.

In step 208 an authentication message comprising the user identity status and the content notification message are sent from the server 6 to the third party platform 4 which uses the user identity status and content notification message to determine that the review can be verified.

In an alternative configuration the server 6 may verify the user, in step 204, by checking that the received user verification data corresponds to data held in the user profile 12 within the data store 10. In this alternative configuration the server 6 has previously verified the user with the issuer 8 during a registration process as described in FIG. 2 and the outcome of that registration process has been recorded in a user profile 12 in the data store 10. In the subsequent analysis of received content data, rather than verifying that the received user verification data corresponds to an active account with the issuer 8, the user verification process comprises checking the received user verification data against the plurality of user profiles 12 in the data store 10 to determine if a user profile exists with the corresponding user verification data and which is associated with the same third party platform user account name.

In a further alternative configuration user profiles in either the data store 10 or data store 11 may include one or more profile images that have previously been associated with the user. The content data received from the third party platform may comprise an image submitted by the user to the third party platform 4. In such further alternative configuration, the authentication server 6 may use the received user verification data to look up a user profile and to perform an image comparison against the previously provided profile image(s) in the user profile. In the event that the image submitted by the user to the third party platform 4 matches the previously provided profile image then the server 6 may generate a content notification message that indicates that a match exists between the images. The content notification message, along with a user identity status (which may be determined as described above from the provided user verification data), may be sent back to the third party platform 4 in an authentication message.

In a yet further configuration, the third party provider 4 may request that the authentication server 6 provide user related data in response to the content data sent from the platform 4. In this configuration the server 6 receives user verification data and content data, the content data being in the form of a data request for user data. The authentication server 6 may first verify the user verification data to determine that the identity of the user (this verification may for example comprise searching the plurality of user profiles 12 with the data store 10 to find and retrieve a user profile). The authentication server 6 may then analyze the data request and extract a subset of user data from the user profile 12. The extracted data may then be formatted according to the requirements of the platform 4 into a content data notification message and an authentication message comprising a user identity status and the content data notification message sent back to the third party platform 4. In this manner the content data analysis system may be used to autofill user data into a form.

Many modifications may be made to the specific embodiments described above without departing from the scope of the invention as defined in the accompanying claims. Features of one embodiment may also be used in other embodiments, either as an addition to such embodiment or as a replacement thereof. It is to be understood that a payment card and a mobile device are used in the present disclosure as non-limiting examples of transaction devices. In other embodiments, the transaction device may be an alternative transaction device carrying card data, e.g. tablets or watches.

1. A method of processing, at an authentication server, content data provided during an interaction between a user and a third party platform, the method comprising:
receiving, at the authentication server, user verification data and content data from the third party platform;
verifying the identity of the user by comparing the received user verification data against verification data stored in a user profile in order to generate a user identity status;
analysing received content data against pre-existing user data in order to generate a content data notification message;
sending, from the authentication server to the third party platform, an authentication message, the authentication message comprising the user identity status and the content data notification message.

2. A method as claimed in claim 1, wherein the verification data stored in the user profile comprises user bank account data and the user verification data received at the authentication server comprises data associated with the user bank account.

3. A method as claimed in claim 2, wherein verification of the identity of the user comprises checking that the received data associated with the user bank account matches the user bank account data stored in the user profile.

4. A method as claimed in claim 2, wherein the user profile comprises primary account number (PAN) data and the received user verification data comprises a PAN number.

5. A method as claimed in claim 1, wherein the content data received from the third party platform relates to a user-merchant transaction between a user and a merchant and wherein the pre-existing user data comprises historical transaction data of the user.

6. A method as claimed in claim 5, wherein analysing the received content data against pre-existing user data comprises determining if a match exists between the historical transaction data in the user profile and the user-merchant transaction contained in the received content data.

7. A method as claimed in claim 1, wherein the content data received from the third party platform comprises an image of submitted by the user and the pre-existing user data comprises a profile image of the user.

8. A method as claimed in claim 7, comprising analysing the submitted user image against the profile image to determine if a match exists between the user in the submitted image and the pre-existing user profile image.

9. A method as claimed in claim 6, wherein the content data notification message comprises an indication whether or not a match exists between the content data received from the third party platform and the data within the user profile.

10. A method as claimed in claim 1, wherein the content data received from the third party platform comprises a request for pre-existing user data in order to populate a form and wherein analysing the received content data comprises extracting user data from the pre-existing user data.

11. A method as claimed in claim 10, wherein the content data notification message comprises the user data requested by the third party platform.

12. A method as claimed in claim 11, wherein the content data received from the third party platform comprises a content formatting specification and the content data notification message comprises user data extracted from pre-existing user data and formatted according to the content formatting specification.

13. A method as claimed in claim 1, comprising generating at the authentication server a consent notification message to send to the user to allow the user to consent to the verification of their verification data and analysis of content data.

14. A method as claimed in claim 13, wherein the consent notification message is sent via a second authenticated communications channel.

15. A method as claimed in claim 1, wherein the user is requesting a third party provider user account and verifying the identity of the user comprises checking whether the received user verification data is already associated with another third party provider user account.

16. (canceled)

17. (canceled)

18. A computer-readable storage medium comprising instructions which, when executed by a computer, cause the computer to carry out the method of claim 1.

19. An authentication server arranged to process content data provided during an interaction between a user and a third party platform, the server comprising:
an input arranged to receive, at the authentication server, user verification data and content data from the third party platform;
a processor arranged to verify the identity of the user by comparing the received user verification data against verification data stored in a user profile in order to generate a user identity status; and to analyse received content data against pre-existing user data in order to generate a content data notification message;
an output arranged to send to the third party platform, an authentication message, the authentication message comprising the user identity status and the content data notification message.
